(19) United States
(12) Patent Application Publication
(10) Pub. No.: US 2016/0198633 A1
(43) Pub. Date: Jul. 14, 2016

(54) Bale Fork Attachment

(71) Applicant: Gary Machado, Carrollton, TX (US)

(72) Inventor: Gary Machado, Carrollton, TX (US)

(21) Appl. No.: 14/970,736

(22) Filed: Dec. 16, 2015

Related U.S. Application Data
(60) Provisional application No. 62/102,177, filed on Jan. 12, 2015.

(51) Int. Cl. A01D 87/12; B66F 9/14

(52) U.S. Cl. CPC A01D 87/127; B66F 9/144

(57) ABSTRACT

A bale fork attachment that is removably mounted to a tractor to facilitate the transport of bales of hay. The bale fork attachment includes a frame having a front side, a back side, and a lower side, wherein the back side includes a coupling device that removably mounts the bale fork attachment to the tractor. The lower side includes a pair of spears that extend orthogonally in relation to the front side in a parallel configuration forming a space therebetween. The lower side further includes a channel on each end that is configured to slidably receive the pair of spears so that the lateral positioning of the pair of spears can be adjusted. A hydraulic assembly is operably connected to at least one of the spears to provide automatic movement thereof.

### CROSS REFERENCE TO RELATED APPLICATION

This application claims the benefit of U.S. Provisional Application No. 62/102,177 filed on Jan. 12, 2015. The above identified patent application is herein incorporated by reference in its entirety to provide continuity of disclosure.

### FIELD OF THE INVENTION

The present invention relates to the loading, hauling and transporting of crops that are bundled into bales. More particularly, the present invention provides a bale fork attachment for a tractor that includes a pair of spears that are aligned in a parallel configuration forming a space therebetween. The lateral positioning of the spears is adjustable so that the spears can be moved towards or away from each other for use in carrying one or more hay bales.

### BACKGROUND OF THE INVENTION

Cut and raked crops, such as hay, cotton, straw, or silage, are often compressed and bundled into bales to facilitate transport, handling, and storage. Bales are often bundled into rectangular or cylindrical shapes and bound with some sort of twine or wire. Generally, the most conventional shape of bales are the round bales, but due to its shape, they are prone to rolling down a slope. Thus, these round bales require specific treatment to facilitate transport and handling to avoid problems.

Typically, the most conventional tool for handling bales, such as the round bales, is the bale spear. The bale spear is usually mounted to the front end of a tractor, wherein the driver of the tractor inserts the bale spear through the bale to lift and haul the bale. The bale is set down when it reaches its destination and the bale spear is removed. However, these bale spears are difficult to use because the bale spear needs to be carefully placed within the center in order to provide the driver with the most control over the lifted bale. Therefore, there exists a need for bale fork attachment that is configured to improve and facilitate the transport of bales of hay and other similarly bundled material.

Devices have been disclosed in the prior art that relate to hay forks. These include devices that have been patented and published in patent application publications. Some of these devices provide hydraulically tilting bale spears that extend or retract in distance from a neighboring spear. Other devices provide a three point bale spear attachment for transporting round bales of hay. These devices, however, fail to provide a bale fork attachment that includes a pair of spears, wherein a hydraulic assembly moves one of the spears to widen or narrow the space between the moving spear and the stationary spear that is manually adjustable.

The present invention provides a bale fork attachment that facilitates the transport of bales of hay and other similarly bundled material. The bale fork attachment includes a frame having a front side, a back side, and a lower side. The lower side includes a pair of spears that extend orthogonally in relation to the front side in a parallel configuration forming a space therebetween. The lower side includes a channel that is configured to telescopically receive the pair of spears at its ends. One spear is manually adjustable via a fastener, while the second spear is in fluid communication with a hydraulic assembly that is configured to widen or narrow the space between the pair of spears. The back side includes a coupling device configured to removably mount the bale fork attachment to a tractor.

It is therefore submitted that the present invention is substantially divergent in design elements from the prior art, and consequently it is clear that there is a need in the art for an improvement to bale. In this regard, the instant invention substantially fulfills these needs.

### SUMMARY OF THE INVENTION

In view of the foregoing disadvantages inherent in the known types of bale fork attachments now present in the prior art, the present invention provides a bale fork attachment wherein the same can be utilized for facilitating the transport of bales of hay or other similarly bundled material through the use of a hydraulic assembly.

It is therefore an object of the invention to provide a new and improved bale fork attachment that has all of the advantages of the prior art and none of the disadvantages.

Another object of the present invention is to provide a new and improved bale fork attachment including a frame having a front side, a back side, and a lower side, wherein the lower side includes a pair of spears that extend orthogonally in relation to the front side in a parallel configuration to form a space therebetween.

Yet another object of the present invention is to provide a new and improved bale fork attachment, wherein the lower side further includes a hydraulic assembly configured to be in fluid communication with one of the pair of spears to widen or narrow the space therebetween.

Still yet another object of the present invention is to provide a new and improved bale fork attachment, wherein the back side includes a coupling device configured to removably mount to a tractor.

Another object of the present invention is to provide a new and improved bale fork attachment, wherein the lower side includes a first end and a second end forming a square channel that is configured to telescopically receive one of the pair of spears at each end.

A further object of the present invention is to provide a new and improved bale fork attachment, wherein the pair of spears each include a shaft that is orthogonally affixed to each spear configured to be telescopically received within each end of the channel.

Yet a further object of the present invention is to provide a new and improved bale fork attachment, wherein one of said pair of spears is adjustable along a length of the channel via a fastener.

Still yet another object of the present invention is to provide a new and improved bale fork attachment wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the bale fork attachment.

FIG. 2 shows a rear perspective view of the bale fork attachment.

FIG. 3 shows a side perspective view of the bale fork attachment in use.

FIG. 4 shows a rear perspective view of the bale fork attachment in use.

### DETAILED DESCRIPTION OF THE INVENTION

Reference is made herein to the attached drawings. Like reference numerals are used throughout the drawings to depict like or similar elements of the bale fork attachment. For the purposes of presenting a brief and clear description of the present invention, the preferred embodiment will be discussed as used to facilitate the transport of bales of hay or other similarly bundled material. The figures are intended for representative purposes only and should not be considered to be limiting in any respect.

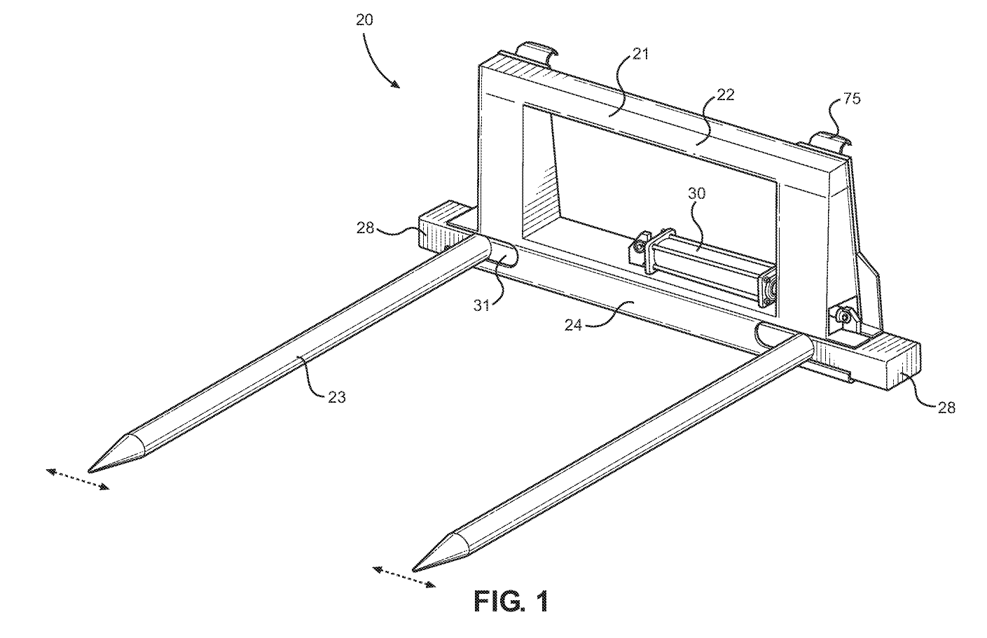

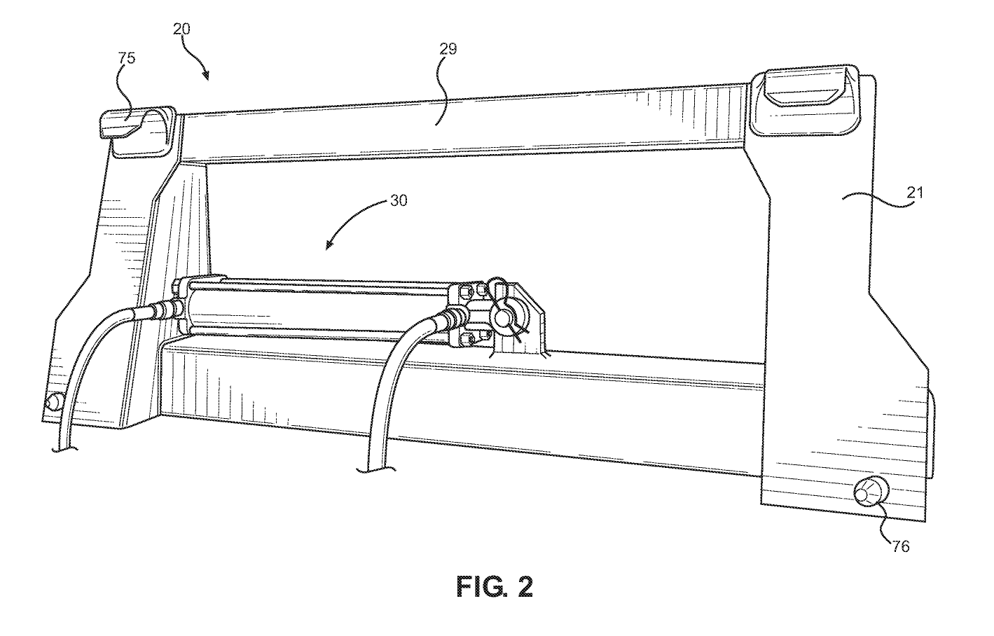

Referring now to FIGS. 1 and 2, there is shown a front perspective view and a rear perspective view of the bale fork attachment. The bale fork attachment 20 is configured to removably mount to a tractor to allow a user to facilitate the transport of bales of hay. It is contemplated that the bale fork attachment 20 is also configured to transport bales of other similarly bundled material. The bale fork attachment 20 comprises a frame 21 having a front side 22 and a back side 52. The frame 21 is preferably substantially rectangular in shape and is adapted to be disposed in a substantially vertical orientation wherein the width of the frame 21 is greater than the height thereof.

The front side 22 of the frame 21 comprises a pair of spears 23 that extend outward therefrom such that the spears 23 are perpendicular to the frame 21 and are parallel to one another. The spears 23 are preferably arranged in a substantially horizontal orientation when the bale fork attachment 20 is in use. The spears 23 are disposed on opposing sides of the frame 21 and are preferably coplanar.

Preferably, each spear 23 is movably affixed to the frame 21. Each spear 23 is disposed on a shaft 28 that is slidably positioned within a channel 25 on the lower end 24 of the frame 21. In this way, when the shaft 28 is moved within the frame 21, the positioning of the spear 23 is similarly adjusted. This allows for lateral adjustment of the spears 23 so as to increase or decrease the separation between the pair of spears 23.

A hydraulic assembly 30 is affixed to the frame 21 and is adapted to automatically control the movement of at least one spear 23. In this way, the user can operate the hydraulic assembly 30 so as to cause the shaft 28 of a spears 23 to move within the channel 25. This eliminates the need for the user to manually adjust the position of the spear 23 by hand. Further, the hydraulic assembly 30 helps to lock the spear 23 in the desired position once moved within the channel 25. Preferably, a control is provided so as to allow the user to remotely control the operation of the hydraulic assembly 30.

In some embodiments, only one spear 23 is movable and the other spear 23 is fixed in position. In this way, the hydraulic assembly 30 is used to move a single spear 23 so as to adjust the separation between the spears. In alternate embodiments, both spears 23 are adjustable via the hydraulic assembly 30. Furthermore, in some embodiments, one spear 23 is adjustable via the hydraulic assembly 30 and the other spear 23 is manually adjustable.

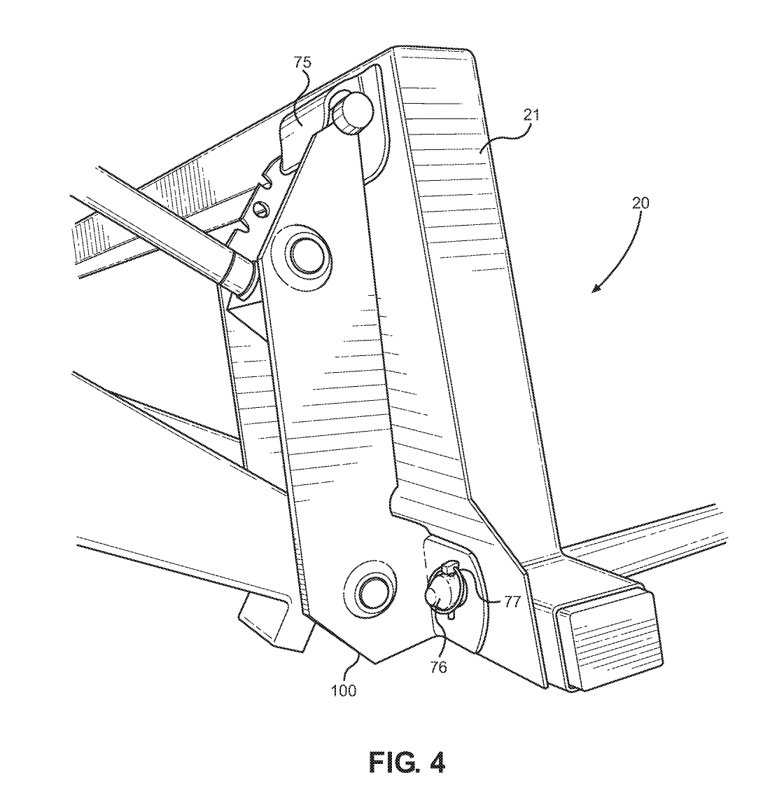

The back side 52 of the frame 21 includes a coupling device 75 that allows for the bale spear attachment 20 to be removably mounted to a tractor. Preferably, the coupling device includes a plurality of fasteners configured to removably secure the bale spear attachment 20 to the tractor. As illustrated in FIGS. 2 and 4, the plurality of fasteners include a pair of mounting brackets configured to removably mount to the tractor 100. These mounting brackets are preferably affixed on an upper end 40 of the frame 21. The lower end 24 includes a pair of protrusions 76, each having an aperture therethrough configured to receive a pin 77. In this way, the bale fork attachment 20 is removably mounted to the tractor 100. It is contemplated that other coupling devices and systems are suitable to achieve the function and advantages described within the present disclosure. These coupling devices and systems are deemed within the scope and spirit of the inventive embodiments of the present disclosure.

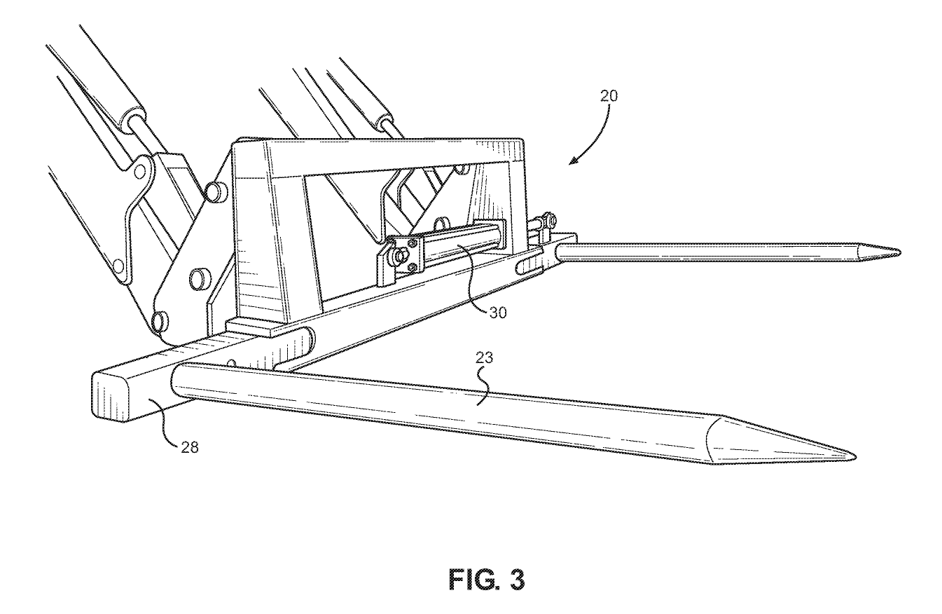

Referring now to FIG. 3, there is shown a side perspective of the bale spear attachment. The hydraulic assembly 30 is configured to allow the pair of spears 23 to extend and retract from one another, wherein the space therebetween widens or narrows in order to load, haul and stack bales of hay or other similarly bundled material.

The bale fork attachment 20 can be used to load bales of hay in at least two different ways. The first way is to use the bale fork attachment 20 in a retracted configuration where the space between the pair of spears 23 extends the length of the square channel 25. The bale fork attachment 20 is used conventionally in this configuration, wherein the pair of spears pierce through the bales of hay to facilitate the transfer. The second way to use the bale fork attachment 20 is accomplished through the use of the hydraulic assembly 30. The moving spear 23 is extended or retracted from the stationary spear 23 to lift and stabilize the bale of hay between the pair of spears 23.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A bale fork attachment, comprising:
a frame including a front side and a back side;
a coupling device disposed on the back side and configured to removably attach to a tractor;
a pair of spears movably connected to a front side of the frame;
a hydraulic assembly operably connected to at least one of the pair of spears and configured to allow for lateral adjustment thereof.

2) The bale fork attachment of claim 1, wherein each of the pair of spears is movably positioned within a channel disposed on the frame.

3) The bale fork attachment of claim 1, wherein the pair of spears are positioned orthogonally relative to the frame, and wherein the pair of spears are parallel to one another.

4) The bale fork attachment of claim 1, wherein one spear in the pair of spears is permanently affixed to the frame.

5) The bale fork attachment of claim 1, wherein said plurality of fasteners include a pair of mounting brackets affixed to said upper side on said back side configured to removably mount to said tractor.
